(19) United States
(12) Patent Application Publication
(10) Pub. No.: US 2023/0129363 A1
(43) Pub. Date: Apr. 27, 2023

(54) MEMORY OVERLAY USING A HOST MEMORY BUFFER

(71) Applicant: MICRON TECHNOLOGY, INC., Boise, ID (US)

(72) Inventor: Meng Wei, Shanghai City (CN)

(21) Appl. No.: 17/275,567

(22) PCT Filed: Aug. 7, 2020
(86) PCT No.: PCT/CN2020/107787

§ 371 Date: Mar. 11, 2021

(51) Int. Cl. G06F 3/06

(52) U.S. Cl. CPC G06F 3/0611; G06F 3/0656; G06F 3/0673

(57) ABSTRACT

Two or more overlay sections are copied from a non-volatile memory device of a memory sub-system to a first memory buffer residing on a first volatile memory device of a host system in communication with the memory sub-system. Each overlay section includes a respective set of executable instructions. A first overlay section is copied from the host memory buffer to a second memory buffer residing on a second volatile memory device of the memory sub-system. A first set of executable instructions included in the first overlay section residing in the second memory buffer is executed. A second overlay section is copied from the host memory buffer to the second memory buffer. A second set of executable instructions included in the second overlay section residing in the second memory buffer is executed.

### TECHNICAL FIELD

Embodiments of the disclosure relate generally to memory sub-systems, and more specifically, relate to memory overlay using a host memory buffer.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing environment that includes a memory sub-system, in accordance with some embodiments of the present disclosure.

FIG. 2 illustrates memory overlay using a host memory buffer, in accordance with some embodiments of the present disclosure.

FIG. 3 is a flow diagram of an example method to perform memory overlay using a host memory buffer, in accordance with some embodiments of the present disclosure.

FIG. 4 is a flow diagram of another example method to perform memory overlay using a host memory buffer, in accordance with some embodiments of the present disclosure.

FIGS. 5A-C illustrate memory overlay at a memory sub-system using a host memory buffer, in accordance with some embodiments of the present disclosure.

FIG. 6 is a block diagram of an example computer system in which embodiments of the present disclosure may operate.

### DETAILED DESCRIPTION

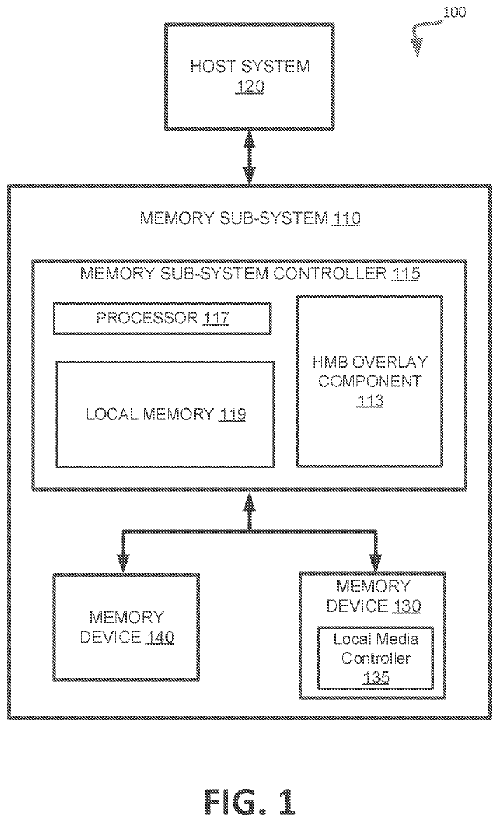

Aspects of the present disclosure are directed to systems and methods to memory overlay using a host system memory buffer. A memory sub-system can be a storage device, a memory module, or a hybrid of a storage device and memory module. Examples of storage devices and memory modules are described below in conjunction with FIG. 1. In general, a host system can utilize a memory sub-system that includes one or more memory components (also hereinafter referred to as “metnory devices”). The host system can provide data to be stored at the memory sub-system and can request data to be retrieved from the memory sub-system.

A memory sub-system can include multiple memory devices that are each associated with different memory latencies. A memory access latency refers to an amount of time elapsed for servicing a request for data or code stored at a memory device. In some conventional systems, a memory sub-system controller can copy a first section of code stored at a memory device exhibiting a high access latency, referred to as a high latency memory device, to a memory device associated with a lower access latency, referred to a low latency memory device. For example, a low latency memory device can he a dynamic random access memory (DRAM) device and a high latency memory device can be a non-volatile memory device (e.g., a flash memory device). The memory sub-system controller can execute the first code section residing on the low latency memory device. in some instances, the first code section can include a reference (i.e., a jump instruction) to a second code section stored at the high latency memory device. The memory sub-system controller can remove the first code section from the low latency memory device and copy the second code section from the high latency device to the low latency device. The memory sub-system controller can then execute the second code section residing on the low latency memory device. This technique is referred to memory overlay or memory overlaying.

Memory overlay can be used to reduce an overall mernor sub-system latency. For example, in memory sub-systems including a DRAM device, the memory sub-system controller can overlay code sections stored at a non-volatile memory device (e.g., a NAND flash memory device) to the DRAM device. However, some memory sub-systems do not include a DRAM device and instead include only a static RAM (SRAM) device or a tightly coupled memory (TCM) device. A storage capacity of a SRAM device and/or a TCM device can be significantly smaller than a storage capacity of a non-volatile memory device. Therefore, only a small portion of code stored at the high latency memory device can be copied to the low latency memory device at a given time. The memory sub-system controller performs a significant amount of copying operations to copy code from the high latency memory device to the low latency memory device during operation of the memory sub-system. As a result of the significant amount of copying operations and the high latency associated with the high latency memory device, a reduction in the overall memory sub-system latency is minimal at best.

Aspects of the present disclosure address the above and other deficiencies by having a memory sub-system that uses a memory butler of a host system (referred to herein as a host memory buffer) to facilitate memory overlay during operation of the memory sub-system. A host memory buffer can be part of a memory device that is associated with a latency that is lower than a high latency memory device (e.g., a non-volatile memory device). For example, a host memory buffer can reside on DRAM device of the host system.

The high latency memory device, such as a non-volatile memory device, can store multiple overlay sections each including one or more code sections to be executed during operation of the memory sub-system. EaCh code section can include a set of one or more executable instructions executed by a memory sub-system controller. During initialization of the memory sub-system, the memory sub-system controller can copy at least a portion of overlay sections stored at the high latency memory device to the host memory butler. In response to determining a particular code section is to be executed by the memory sub-system controller, the memory sub-system controller can identify a first overlay section including the particular code section and determine whether the first overlay section is present in the host memory buffer. In response to determining the first overlay section is present in the host memory buffer, the memory sub-system controller can copy the first overlay section to a buffer residing on a low latency memory device (e.g., a SRAM device, a TCM device, etc.) of the memory sub-system (referred to as a memory sub-system buffer). The memory sub-system controller can execute the particular code section included in the first overlay section from the memory sub-system buffer. The memory sub-system controller can determine that another code section is to be executed by the memory sub-system controller. In response to determining a second overlay section including the code section is present in the host memory buffer, the memory sub-system controller can remove the first overlay section from the memory sub-system buffer and copy the second overlay section from the host memory buffer to the memory sub-system buffer. The memory sub-system controller can then execute the code section included in the second overlay section from the memory sub-system buffer.

Advantages of the present disclosure include, but are not limited to, a decrease in an overall system latency of a memory sub-system and an increase in overall memory sub-system performance. Overlay sections stored at a high latency memory device a non-volatile memory device) are copied to the host memory buffer of a low latency memory device (e.g., a DRAM device) during initialization of the memory sub-system. During operation of the memory sub-system, the memory sub-system controller can copy overlay sections to the memory sub-system buffer from the host memory buffer instead of the high latency memory device. By copying data from the host memory buffer instead of the high latency memory device, a number of copying operations between the high latency memory device and the memory sub-system buffer is significantly reduced, thereby reducing overall system latency and increasing overall system performance. Further, as the host memory buffer resides on a low latency memory device (e.g., a DRAM memory device), data stored at the host memory buffer can be accessed and copied to the memory sub-system buffer more quickly than data copied to the memory sub-system buffer from the high latency memory device, thereby further reducing overall system latency and increasing overall system performance.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded. computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed 1w the processor chipset. The processor chipset can include one or more cores, one or more caches, a memory controller (e.g., NVDIMM controller), and a storage protocol controller (e.g., PCIe controller. SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (D M) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the PCIe interface. The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example. two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a ILC portion of memory cells. The memory cells of the memory devices 130 can be grouped as pages that can refer to a logical unit of the memory device used to store data. With some types of memory (e.g., NAND), pages can be grouped to form blocks.

Although non-volatile memory devices such as 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits andlor discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor

The memory sub-system controller 115 can include a processor 117 (e.g., processing device) configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130, An external controller (e.g., memory sub-system controller 115) can externally manage the memory device 130 (e.g., perform media management operations on the memory device 130). In sonic embodiments, a memory device 130 is a managed memory device, which is a raw memory device combined with a local controller (e.g., local controller 135) for media management within the same memory device package. An example of a managed memory device is a managed NAND (MNAND) device.

In some embodiments, a driver of host system 120 can allocate one or more portions of host system memory to be accessible by memory sub-system controller 115 (referred to herein as host memory buffers). A host memory buffer can store data. or code associated with operation of memory sub-system 110 For example, a logical to physical address table (i.e., a L2P table) can be stored at a first portion of a host memory buffer of host system 120. Memory sub-system controller 115 can access the L2P table stored at the host memory buffer to translate a logical address for a portion of data stored at a memory device 130, 140 to a physical address. In some embodiments, one or more portions of the host memory buffer can store sections of executable code copied from a memory device 130, 140. In such embodiments, the host memory butler can be used to facilitate memory overlay during operation of the memory sub-system 110. The host memory buffer can be associated with a latency that is lower than a latency associated with a memory device 130, 140. For example, the host memory buffer can be a part of a DRAM device and the memory device 130 can be a non-volatile memory device. In some embodiments, a host memory buffer can store a L2P table and executable code sections copied from a memory device 130, 140. In other or similar embodiments, the host memory butler can store executable code sections copied from a memory device 130, 140 without storing the L2P table.

In some embodiments, memory sub-system 110 can include a memory sub-system buffer. In some instances, the memory sub-system buffer can be associated with a latency that is lower than a latency associated with the host memory buffer and a latency associated with a memory device 130, 140. For example, the memory sub-system buffer can be part of a tightly coupled memory (TCM) device or a static random access memory (SRAM) device, the host memory butler can be part of a DRAM device, and the memory device 130 can be a non-volatile memory device. In sonie embodiments, a memory sub-system buffer can be a portion of local memory 119. In other or similar embodiments, the memory device 130 can be a first memory device and the memory sub-system buffer can be part of a second memory device (e.g., memory device 140).

The memory sub-system 110 includes a host memory buffer overlay component 113 (referred to herein as HMB overlay component 113) that facilitates memory overlay using the host memory buffer of host system 120. In some embodiments, the memory sub-system controller 115 includes at least a portion of the HMB overlay component 113. For example, the memory sub-system controller 115 can include a processor 117 (processing device) configured to execute instructions stored in local memory 119 for performing the operations described herein. In some embodiments, the HMB overlay component 113 is part of the host system 110, an application, or an operating system.

The HMB overlay component 113 can facilitate code section overlaying in the memory sub-system buffer. In some embodiments, memory device 130 can store multiple code sections where each code section is included in an overlay section. Each code section can include a set of executable instructions executed by firmware of memory sub-system 110. During initialization of the memory sub-system 110, the HMB overlay component 113 can copy at least a portion of the overlay sections stored at the memory device 130 to the host memory buffer. In response to memory sub-system controller 115 determining a particular code section is to be executed, HMB overlay component 113 can identify a first overlay section of the memory device 130 that includes the particular code section and determine whether the first overlay section is present in the host memory buffer. In response to determining the first overlay section is present in the host memory buffer, the HMB overlay component 113 can copy the first overlay section from the host memory buffer to the memory sub-system buffer. The memory sub-system controller 115 can execute the particular code section included in the first overlay section from the memory sub-system buffer. The memory sub-system controller 115 can determine that another code section is to be executed. In response to determining a second overlay section including the code section is present in the host memory buffer, HMB overlay component 113 can remove the first overlay section from the memory sub-system buffer and copy the second overlay section from the host memory buffer to the memory sub-system buffer. The memory sub-system controller 115 can then execute the code section included in the second overlay section from the memory sub-system buffer. Further details with regards to the operations of the HMB overlay component 113 are described below.

In some embodiments, an overlay section including code associated with executing HMB overlay component 113 can be copied to the memory sub-system buffer during initialization of memory sub-system 110. For example, the overlay section associated with executing HMB overlay component 113 can be copied from memory device 130 to the memory sub-system buffer or from the host memory buffer to the memory sub-system buffer, in accordance with embodiments described herein. In some embodiments, the overlay section associated with executing HMB overlay component 113 can remain in the memory sub-system buffer during operation of memory sub-system 110 and is not removed from the memory sub-system buffer during performance of memory overlay.

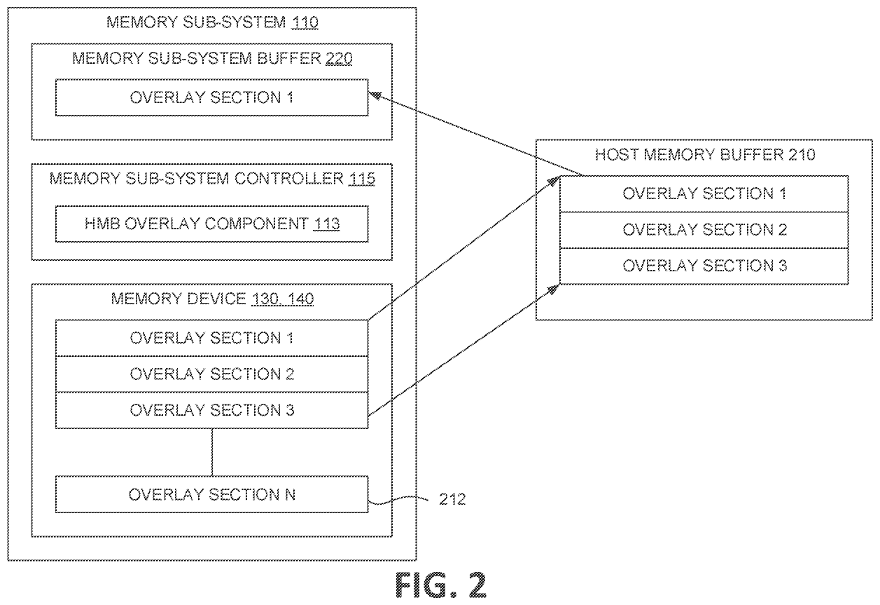

FIG. 2 illustrates memory overlay using a host memory buffer 210, in accordance with some embodiments of the present disclosure. As described previously, memory device 130, 140 can be anon-volatile memory device that stores one or more overlay sections 212. Each overlay section 212 can include a set of executable instructions. During initialization of memory sub-system 110, HHB overlay component 113 can copy one or more overlay sections (e.g., overlay sections 1-N) to host memory buffer 210. As described previously, host memory buffer 210 can reside on a memory device exhibiting a lower latency than memory device 130, 140. For example, host memory buffer 210 can reside on a DRAM memory device. During operation of memory sub-system 110, memory sub-system controller can determine a particular code section stored at the memory device 130, 140 is to be executed. In some embodiments, memory sub-system controller 115 can determine a particular code section is to be executed in response to receiving a request from firmware of memory sub-system 110. HMB overlay component 113 can identify an overlay section 212 of memory device 130 that includes the requested code section and determine whether the identified overlay section 212 is present in host memory buffer 210. In response to determining the overlay section 212 is present in host memory buffer 210, HMB overlay component 113 can copy the overlay section from host memory buffer 210 to memory sub-system buffer 220. As discussed previously, memory sub-system buffer 220 can reside on a memory device associated with a lower latency than host memory buffer 210 and memory device 130, 140. For example, memory sub-system buffer 220 can reside on a TCM memory device or a SRAM memory device.

In an illustrative example, memory sub-system controller 115 can determine a particular code section included in overlay section 1 is to be executed. In response to determining the particular code section is included in overlay section 1. HMB overlay component 113 can determine whether overlay section 1 is present in host memory buffer 210. In response to determining overlay section 1 is present in to host memory buffer 210, HM111 overlay component 113 can copy overlay section 1 from host memory buffer 210 to memory sub-system buffer 220. Memory sub-system controller 115 can execute the code section of overlay section 1 from memory sub-system buffer 220. The memory sub-system controller 115 can determine another code section included in overlay section 2 is to be executed. For example, a portion of the code section of overlay section 1 can include an instruction (i.e., ajump instruction) to execute a portion of the code section of overlay section 2. In response to determining overlay section 2 is present in host memory buffer 210, IIMB overlay component 113 can determine Whether space is available on memory sub-system buffer 220 for copying of overlay section 2. In response to determining that space is not available on memory sub-system buffer 220 for copying of overlay section 2, HAM overlay component 113 can remove overlay section 1 from memory sub-system buffer 220. HMB overlay component 113 can then copy overlay section 2 to memory sub-system buffer 220.

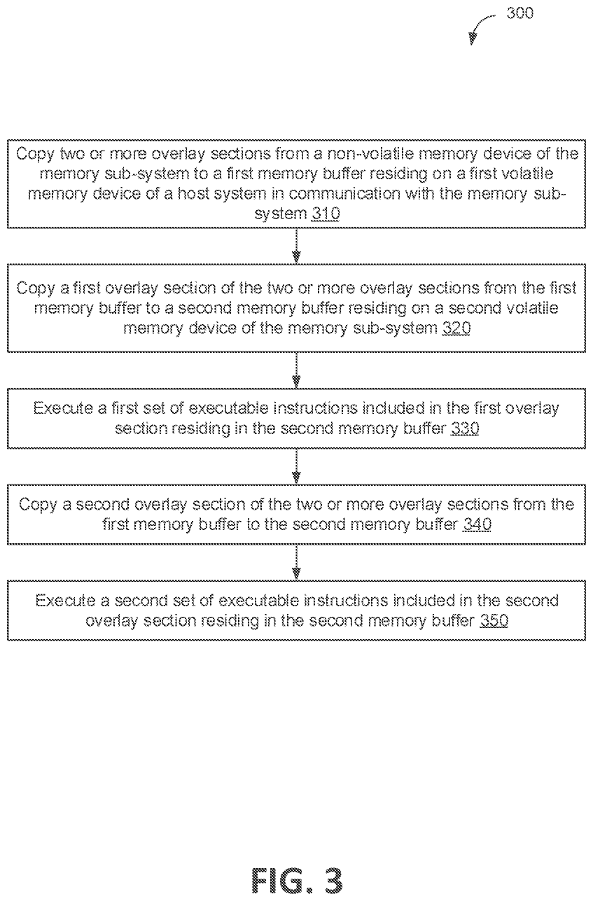

FIG. 3 is a flow diagram of an example method 300 to perform memory overlay using a host memory buffer, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof In some embodiments, the method 300 is performed by the HMB overlay component 113 of FIG. I. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

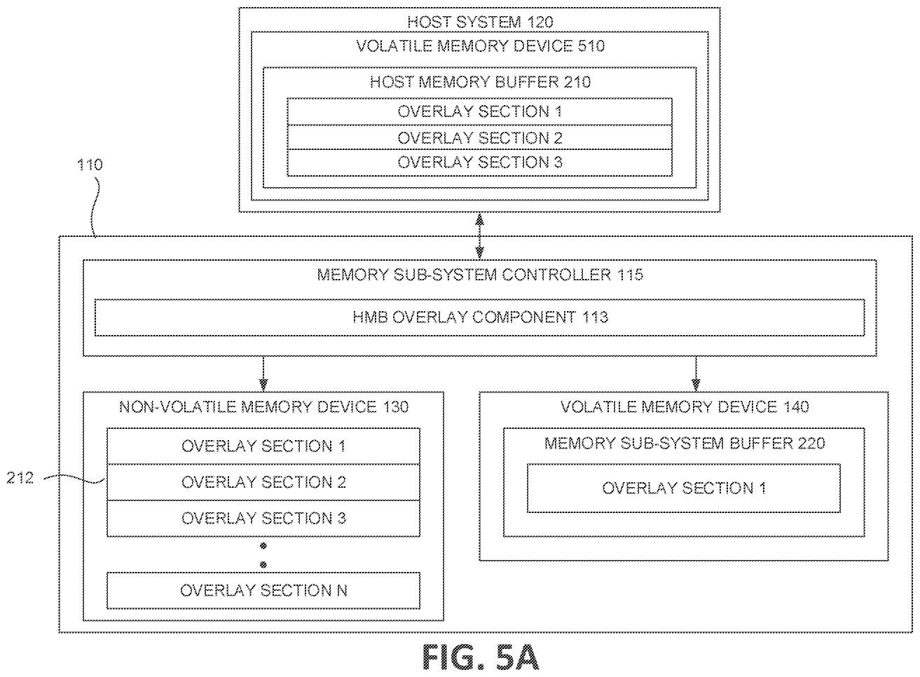

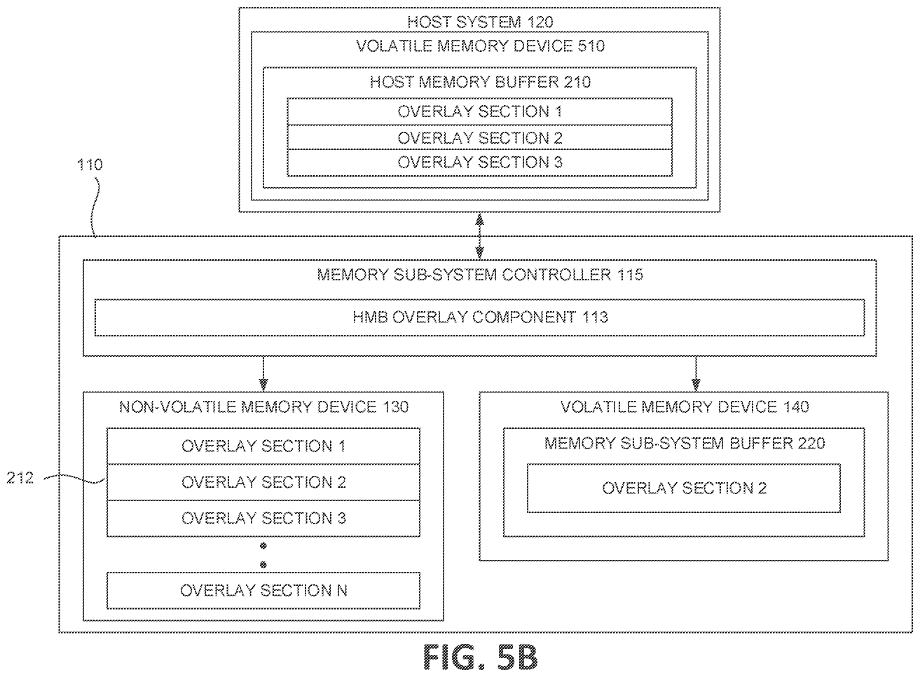

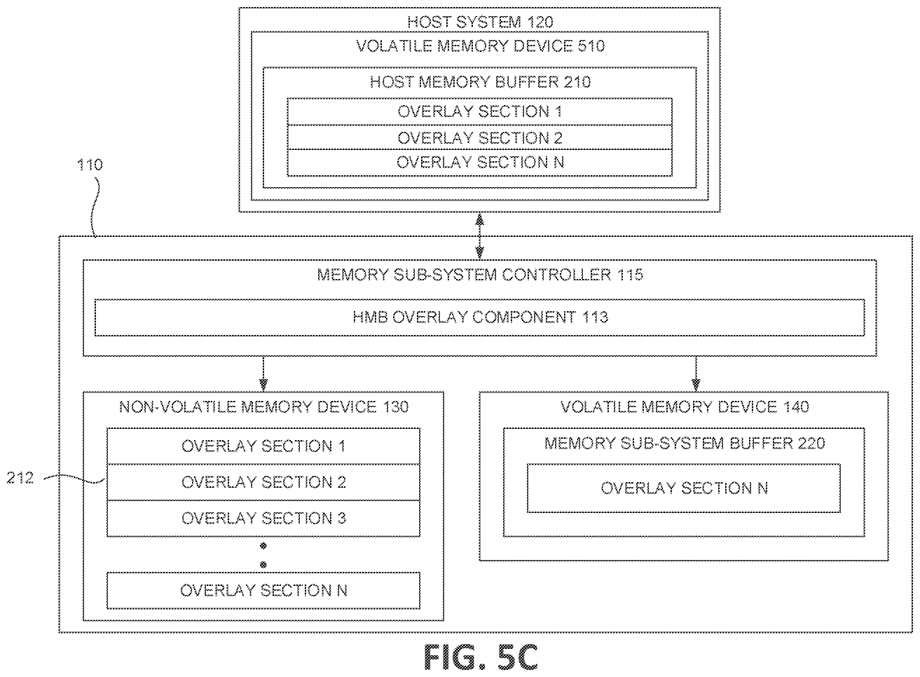

At operation 310, the processing device copies two or more overlay sections from a non-volatile memory device of the memory sub-system to a first memory buffer (i.e., a host memory buffer) residing on a first volatile memory device of a host system in communication with the memory sub-system. Each overlay section can include sections of code stored at the memory device. Each second of code can include a set of executable instructions, as described previously. FIGS. 5A-5C illustrate memory overlay at memory sub-system H 0 using a host memory buffer 210, in accordance with some embodiments of the present disclosure. As illustrated in FIG. 5A, memory device 130 can be a non-volatile memory device. In some embodiments, the processing device of FIG. 3 can include EIMB overlay component 113. HMB overlay component 113 can assign code sections stored at memory device 130 to be included in particular overlay sections 212.

In some embodiments, HMB overlay component 113 can assign code sections to be included in an overlay section 212 based on a frequency that instructions included in a particular code section are executed during operation of memory sub-system 110 (e,g., by firmware of memory sub-system 110, etc.). In some embodiments, HMB overlay component 113 can determine an execution frequency based on an estimated number of instances instructions included in a particular code section are executed during operation of the memory sub-system 110. For example, HMB overlay component 113 can determine the execution frequency for a particular set of instructions based on a measured execution frequency associated with another set of instructions that are similar or related to the particular set of instructions In other or similar embodiments, HMB overlay component 113 can determine the execution frequency based on a measured execution frequency for the set of instructions. For example, HMB overlay component 113 can measure an execution frequency for a set of instructions during operation of memory sub-system 110. HMB overlay component 113 can store the measured execution frequency in non-volatile memory (e.g., memory 130). During initialization (e.g., power up) of memory sub-system 110, HMB overlay component 113 can determine the execution frequency for a particular set of instructions based on the previously measured execution frequency associated with the particular set of instructions stored in non-volatile memory⁻. In other or similar embodiments, the execution frequency for a. particular set of instructions can be provided by a programmer or developer of the particular set of instructions.

In some embodiments, HMB overlay component 113 can identify a first code section and a second code section stored at memory device 130. The instructions included in the first code section can be associated with a first execution frequency and the second code section can be associated with a second execution frequency. HMB overlay component 113 can compare the first execution frequency to the second execution frequency. In response to determining the first execution frequency is lower than the second execution frequency, HMB overlay component 113 can determine the instructions associated with the first code section are executed less frequently than the instructions associated with the second code section during operation of memory sub-system 110. As such, HMB overlay component 113 can include the first code section in a first overlay section 212 and the second code section in a second overlay section 212.

In some embodiments, memory device 130 can store code sections that include instructions that are critical to the performance or operation of the memory sub-system 110 or host system 120 (e.g., data associated with a handler for a frequently executed command). HMB overlay component 113 can identify code sections that include critical instructions and include such code sections together in an overlay section 212. In some embodiments, HMB overlay component 113 can determine whether an instruction is a critical instruction based on an indication provided by a programmer or developer of a code section. In other or similar embodiments, HMB overlay component 113 can determine that an instruction is a critical instruction based on based on a similarity or a relation between a known critical instruction and instructions included in code sections stored at memory device 130. Responsive to determining that a code section stored at memory device 130 includes a critical instruction, HMB overlay component 113 can include the code section in a particular overlay section 212.

In some embodiments, IIMB overlay component can include code sections in an overlay section 212 that include instructions that reference other instructions of the overlay section 212, HMB overlay component 113 can identify a first code section and a second code section stored at memory device 130. HMB overlay component 113 can determine whether an instruction included in the first code section includes a reference to an instruction included in the second code section. In response to determining that the instruction included in the first code section includes a reference to an instruction included in the second code section, HMB overlay component 113 can include the first code section and the second code section in a single overlay section 212. In response to determining the first code section does not include an instruction that references an instruction in the second code section. HMB overlay component 113 can include the first code section in a first overlay section 212 and the second code section in a second overlay section 212.

HMB overlay component 113 can allocate one or more portions of the host memory buffer 210 for copying of one or more overlay sections 212. In some embodiments, HMB overlay component 113 can transmit a request to host system 120 to allocate one or more portions of host memory buffer 210 for overlay sections 212 of memory device 130. In other or similar embodiments, HMB overlay component 113 can allocate the portions of host memory buffer 210 without transmitting a request to host system 120. HMB overlay component can allocate a particular number of portions and/or a particular amount of space of host memory buffer 210 for overlay sections 212. In some embodiments, HMB overlay component 113 can include the particular number of portions and/or the particular amount of space in a request transmitted to host system 120. Responsive to receiving the request from HMB overlay component 113, a driver of host system 120 can identify one or more available portions of host memory buffer 210 and allocate the one or more available portions of host memory buffer 210 for overlay sections 212, in accordance with the request. The driver of host system 120 can transmit an indication of the one or more portions of host memory buffer 210 reserved for overlay sections 212. In some embodiments, the indication can include an amount of space included in the reserved portions of host memory buffer 210. In other or similar embodiments, the indication can include a memory address for each allocated portion of host memory buffer 210.

As described with respect to FIG. 2, HMB overlay component 113 can copy two or more overlay sections 212 to the host memory buffer 210. As illustrated in FIG. 54, host memory buffer 210 can reside in a volatile memory device, such as volatile memory device 510. In some embodiments, HMB overlay component 113 can copy the two or more overlay sections 212 during initialization of the memory sub-system 110. In some embodiments, HMB overlay component 113 can copy an overlay section 212 to a reserved portion of host memory buffer 210. HMB overlay component 113 can determine, based on a size an available portion of the host memory buffer 210, a number of overlay sections 212 to copy to the host memory buffer 210. In some embodiments, the size of the available portion of the host memory buffer 210 may be smaller than a total size or a total number of overlay sections 212 of memory device 130. In such embodiments, HMB overlay component 113 can copy overlay sections 212 to the available portion of host memory buffer 210 until the host memory buffer 210 is no longer available for copying (i.e., host memory buffer 210 does not include an available portion). As a result, HMB overlay component 113 does not copy all overlay sections 212 to host memory buffer 202. For example, as illustrated with respect to FIG. 54, HMB overlay component 113 copies each of overlay section 1, overlay section 2, and overlay section 3 to host memory buffer 210 until host memory buffer 210 is no longer available for copying (i.e., no additional space is available in any allocated portion of host memory buffer 210). As a result, HMB overlay component 113 does not copy additional overlay sections 212 stored at memory device 130 (e.g., overlay section N) to host memory buffer 210.

In some embodiments, HMB overlay component 113 can maintain an overlay data structure configured to track code sections included in overlay sections 212 and overlay sections 212 present in host memory buffer 210. For example, the overlay data structure can include an entry for each overlay section 212 of memory device 130. Each entry can include one or more memory addresses for each code section included in the overlay section 212. In response to copying an overlay section 212 from memory device 130, HMB overlay component 113 can update an entry for the overlay section 212 to indicate that the overlay section 212 is copied at the host memory buffer 210. In some embodiments, the overlay data structure entry can further include an indication of the portion of host memory buffer 210 that includes the copied overlay section 212. In other or similar embodiments, HMB overlay component 113 can track overlay sections 212 present in host memory buffer 210 in accordance with other implementations.

Referring back to FIG. 3, at operation 320, the processing device can copy a first overlay section of the two or more overlay sections from the first memory buffer to a second memory buffer residing on a second volatile memory device of the memory sub-system. In some embodiments, the second volatile memory device can be a local memory device, such as local memory 119. In other or similar embodiments, the second memory device can be a memory device of memory sub-system 110 (e.g., memory device 140), as illustrated in FIG. 5A, The second memory buffer residing on the second volatile memory device can be memory sub-system buffer 220 of

In some embodiments, HMB overlay component 113 can copy a first overlay section to memory sub-system buffer 220 of FIG. 5A in response to determining a first code section of the first overlay section 212 is to be executed. 11M13 overlay component 113 can identify a first overlay section 212 of memory device 130 that includes the first code section. In some embodiments, HMB overlay component 113 can identify the first overlay section 212 of memory device 130, 140 that includes the first code section using an overlay section identification function. For example. HMB overlay component 113 can provide a memory address for one or more instructions associated with the first code section as a parameter value to the overlay section identification function. HMB overlay component 113 can receive, as an output of the overlay section identification function, an indication that the one or more instructions are included in the first overlay section 212. In other or similar embodiments, HMB overlay component 113 of FIG. 2 can identify a first overlay section 212 of memory device 130 that includes the first code section using the overlay data structure, For example, HMB overlay component 113 can compare a memory device address associated with the first code section with one or more memory device addresses of entries of the overlay data structure. In response to determining the memory device address for the first code section corresponds to a memory device address for an entry of the overlay data structure for the first overlay section 212, HMB overlay component 113 can determine the first code section is included in the first overlay section 212.

In response to determining the first code section is included in the first overlay section 212, HMB overlay component 113 can determine whether the first overlay section 212 is present in the host memory buffer 210. In some embodiments, HMB overlay component 113 can determine whether the first overlay section 212 is present in the host memory buffer 210 using the overlay data structure. For example, HMB overlay component 113 can determine, based on an overlay data structure entry for the first overlay section 212, whether the first overlay section 212 is present in the host memory buffer 210. In response to determining the first overlay section 212 is present in the host memory buffer 210, HMB overlay component 113 can copy the first overlay section to the memory sub-system buffer 220. In response to determining the first overlay section 212 is not present in the host memory buffer 210, HMB overlay component 113 can copy the first overlay section from the memory device 130, 140 to the host memory buffer 210, in accordance with embodiments described herein. At operation 230, the processing device can execute the first set of executable instructions included in the overlay section residing in the memory sub-system buffer 220.

At operation 340, the processing device can copy a second overlay section of the two or more overlay sections from the first memory buffer (i.e., the host memory buffer 210) to the second memory buffer (i.e., the memory sub-system buffer 220). in some embodiments, HMB overlay component 113 can copy the second overlay section to memory sub-system buffer 220 of FIG. 54 in response to determining a second code section of the second overlay section 212 is to be executed, in accordance with previously described embodiments. HMB overlay component 113 can determine whether the second overlay section 212 resides on the host memory buffer 210. In response to determining the second overlay section 212 resides on the host memory buffer 210, HMB overlay component can determine whether a space is available on memory sub-system buffer 220 for copying the second overlay section 212. In some embodiments, HMB overlay component can determine space of memory sub-system buffer 220 is not available for copying of the second overlay section 212. For example, HMB overlay component 113 can determine space of memory sub-system buffer 220 is not available for copying of overlay section 2 because overlay section 1 resides in memory subs-system buffer 220. As illustrated in FIG. 5B, HMB overlay component 113 can remove or erase overlay section 2 from memory sub-system buffer 220 and subsequently copy overlay section 2 from host memory buffer 210 to memory sub-system buffer 220. At operation 350, the processing device can execute the second set of executable instructions residing in the second memory buffer, in accordance with previously described embodiments.

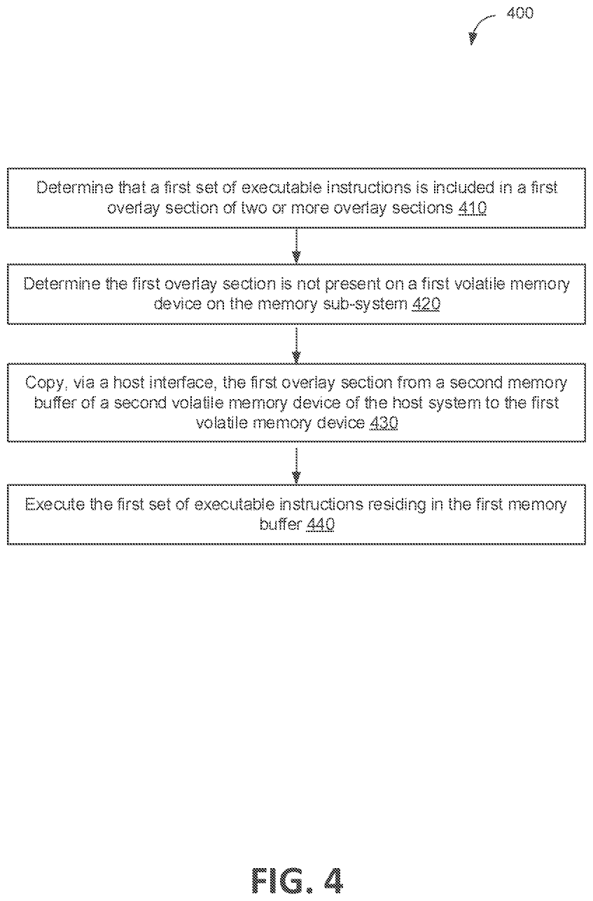

FIG. 4 is a flow diagram of another example method 400 to perform memory overlay using a host memory buffer, in accordance with some embodiments of the present disclosure. The method 400 can be performed by processing logic that can include hardware (e,g., processing device, circuitry, dedicated logic, programmable logic, microcode, hardware of a device, integrated circuit, etc.), software (e.g., instructions run or executed on a processing device), or a combination thereof In some embodiments, the method 400 is performed by the HMB overlay component 113 of FIG. 1. Although shown in a. particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing device can determine that the first set of executable instructions is included in a first overlay section of two or more overlay sections. The processing device (e.g., HMB overlay component 113) can determine the first set of executable instructions is included in the first overlay section in accordance with previously described embodimerits.

At operation 420, the processing device can determine the first overlay section is not present on the first volatile memory device (i.e., memory sub-system buffer 220) on the memory sub-system. In some embodiments, the processing device (e.g., HMB overlay component 113) can determine the first overlay section 212 is not present on the first volatile memory device 140 using the overlay data structure, as previously described. For example, HMB overlay component 113 can identify an entry of the overlay data structure corresponding to the first overlay section 212. HMB overlay component 113 can determine whether a memory address of the identified entry associated with the first overlay section 212 corresponds to a memory address for memory sub-system buffer 220. In response to determining the memory address does not correspond to a memory address for memory sub-system buffer 220, HMB overlay component 113 can determine the first overlay section 212 is not present on the first volatile device 140.

In some embodiments, in response to determining the first overlay section 212 is not present on the first volatile device 140, HMB overlay component 113 can determine whether the first overlay section 212 is present on a second volatile memory device 510 of host system 120 (i.e., in host memory buffer 210). HMB overlay component 113 can determine whether a memory address of the identified overlay data structure entry associated with the first overlay section 212 corresponds to a memory address for host memory buffer 210. In response to determining the memory address does not correspond to a memory address for host memory buffer 210, HMB overlay component 113 can determine the first overlay section 212 does not reside on volatile memory device 510.

In response to determining the first overlay section does not reside on volatile memory device 510, HMB overlay component 113 can copy the first overlay section 212 from non-volatile memory device 130 to the host memory buffer 210, in accordance with previously described embodiments. HMB overlay component 113 of FIG. 5A can copy the first overlay section 212 from non-volatile memory device 130 to an available portion of host memory buffer 210, in accordance with previously described embodiments, In some embodiments, host memory buffer 210 does not include any portions that are available for copying of the first overlay section 212. In such embodiments, HMB overlay component 113 can identify a candidate overlay section 212 present in host memory buffer 210 to remove or erase from host memory buffer 210. In some embodiments, HMB overlay component 113 can identify the candidate overlay section 212 for removal based on a frequency that instructions of code sections included in candidate overlay section 212 are executed by memory sub-system controller 114. In response to removing or erasing the candidate overlay section 212 from host memory buffer 210, HMB overlay component 113 can copy the first overlay section 212 to the available portion of host memory buffer 210. 100571 In an illustrative example, memory sub-system controller 11.5 can determine a code section included in overlay section N is to be executed. In response to determining that overlay section N is not present in host memory buffer 210, HMB overlay component 113 can determine whether a portion of host memory buffer 210 is available for copying of overlay section N, Responsive to determining host memory buffer 210 does not include an available portion, HMB overlay component 113 can identify a candidate overlay section 212 to be removed or erased from host memory butler 210 (e.g., overlay section 3). As illustrated with respect to FIG. 5C, HMB overlay component 113 can remove or erase overlay section 3 from host memory buffer 210 and copy overlay section N to the newly available portion of host memory buffer 210.

Referring back to FIG. 4, at operation 430, the processing device can copy, via a host interface, the first overlay section from a second memory buffer (e.g., host memory buffer 210) of a second volatile memory device of the host system to the first volatile memory device (e.g., to memory sub-system buffer 220). In some embodiments, the host interface can be a peripheral component interconnect express (PCIe) interface, HMB overlay component 113 can copy the first overlay section 212 from host memory buffer 210 to the available portion of memory sub-system buffer 220. As illustrated in FIG. 5C, HMB overlay component 113 can copy overlay section N from host memory buffer 210 to memory sub-system buffer 220 in response to determining a portion of memory sub-system buffer 220 is available. In other or similar embodiments, memory sub-system buffer 220 does not include a portion available for copying an overlay section 212. In such embodiments, HMB overlay component 113 can remove or erase an overlay section 212 present in memory sub-system buffer 220 and copy the overlay section 212 including the requested code sections from host memory buffer 210 to memory sub-system buffer 220, in accordance with previously described embodiments. As illustrated in FIG. 5C, in response to receiving a request to access overlay N, HMB overlay component 113 can determine whether memory sub-system buffer 220 is available for copying of overlay N. In response to determining that memory sub-system buffer 330 is not available for copying of overlay N, HMB overlay component 113 can remove or erase overlay section 1 from memory sub-system buffer 220 and copy overlay section N from host memory buffer 210 to memory sub-system buffer 220. Referring back to FIG. 4, at operation 440, the processing device can execute the first set of executable instructions included in the first overlay section, in accordance with previously described embodiments.

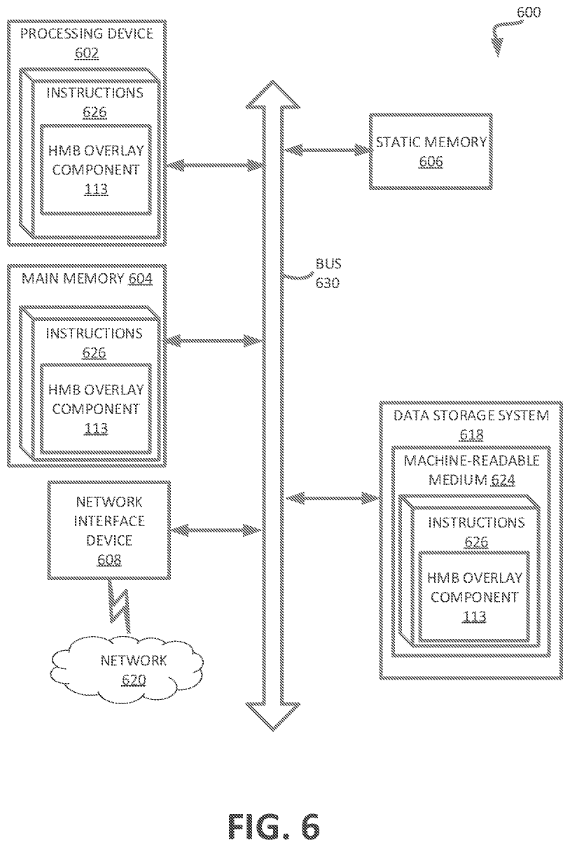

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller e,g., to execute an operating system to perform operations corresponding to the HMB overlay component 113 of FIG. 1). in alternative ethbodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC). a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or RDRAM, etc.), a static memory 606 (e.g., flash memory, static random access memory (SRAM), etc.), and a data storage system 618, whiCh communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 426 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine.-readable storage medium 624, data storage system 618, and/or main memory 604 can correspond to the memory sub-system 110 of FIG. 1.

In one embodiment, the instructions 626 include instructions to implement functionality corresponding to a HMB overlay component (e.g., the HMB overlay component 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. it has proven convenient at times, principally for reasons of common usage, to refer to these simals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can he used to program a computer system (or other electronic devices) to perform a process according to the present disclosure. A machine-readable medium includes any mechanism for storing information in a form readable by a machine (e.g., a computer). in some embodiments, a machine-readable (e.g., computer-readable) medium includes a. machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof It will be evident that various modifications can be made thereto without departing from the broader spirit and scope of embodiments of the disclosure as set forth in the following claims. The specification and drawings are, accordingly, to he regarded in an illustrative sense rather than a restrictive Sense.

What is claimed is:

1. A method comprising:
copying, by a processing device of a memory sub-system, a plurality of overlay sections from a non-volatile memory device of the memory sub-system to a first memory buffer residing on a first volatile memory device of a host system in communication with the memory sub-system, wherein each overlay section of the plurality of overlay sections comprises a respective set of executable instructions;
copying a first overlay section of the plurality of overlay sections from the first memory buffer to a second memory buffer residing on a second volatile memory device of the memory sub-system;
executing, by the processing device of the memory sub-system, a first set of executable instructions included in the first overlay section residing in the second memory buffer;
copying a second overlay section of the plurality of overlay sections from the first memory buffer to the second memory buffer; and
executing, by the processing device of the memory sub-system, a second set of executable instructions included in the second overlay section residing in the second memory buffer.

2. The method of claim 1, further comprising:
assigning one or more sets of executable instructions stored at the non-volatile memory device to a respective overlay section of the plurality of overlay sections.

3. The method of claim 2 further comprising:
identifying the first set of executable instructions and the second set of executable instructions stored at the non-volatile memory device, wherein the first set of executable instructions is associated with a first execution frequency and the second set of executable instructions is associated with a second execution frequency,
wherein the first set of executable instructions is assigned to the first overlay section and the second set of executable instructions is assigned to the second overlay section responsive to determining the first execution frequency is lower than the second execution frequency.

4. The method of claim 2, further comprising:
determining whether an instruction of the first set of executable instructions includes a reference to an additional instruction of a third set of executable instructions,
wherein the first set of executable instructions and the third set of executable instructions are assigned to the first overlay section responsive to determining the instruction of the first set of executable instructions includes a reference to the additional instruction of the third set of executable instructions.

5. The method of claim 1, further comprising:
determining whether space is available on the second memory buffer for copying the second overlay section from the first memory buffer to the second memory buffer, and
responsive to determining that space is not available on the second memory buffer, removing the first overlay section from the second memory buffer,
wherein the second overlay section is copied from the first memory buffer to the second memory buffer responsive to removing the first overlay section from the second memory buffer.

6. The method of claim 1, further comprising:
allocating one or more portions of the first memory buffer for copying of the plurality of overlay sections, wherein the first overlay section and the second overlay section are copied to the one or more allocated portions of the first memory buffer.

7. The method of claim 6, further comprising:
determining, based on at least one of a size or a number of the one or more allocated portions of the first memory buffer, a number of the plurality of overlay sections to be copied to the one or more allocated portions of the first memory buffer.

8. A memory sub-system, comprising:
a first volatile memory device comprising a first memory buffer;
a non-volatile memory device configured to store a plurality of overlay sections, wherein each overlay section of the plurality of overlay sections comprises a respective set of executable instructions;
a host interface to communicate to a host system; and
a processing device to:
determine that a first set of executable instructions is included in a first overlay section of the plurality of overlay sections;
responsive to determining the first overlay section of the plurality of overlay sections is not present on the first volatile memory device of the memory sub-system, copy, via the host interface, the first overlay section from a second memory buffer of a second volatile memory device of the host system to the first memory buffer of the first volatile memory device; and
execute the first set of executable instructions residing in the first memory buffer.

9. The memory sub-system of claim 8, further comprising:
responsive to determining that the first overlay section of the plurality of overlay sections is not present on the second volatile memory device of the host system, copy, via the host interface, the first overlay section from the non-volatile memory device to the second memory buffer of the second volatile memory device of the host system.

10. The memory sub-system of claim 8, wherein to determine, the first set of executable instructions is included in the first overlay section, the processing device is to:
provide a memory address for the first set of executable instructions as a parameter value to an overlay section identification function; and
receive, as an output of the overlay section identification function, an indication that the first set of executable instructions is included in the first overlay section.

11. The memory sub-system of claim 8. wherein to determine whether the first overlay section is present on the first volatile memory device of the memory sub-system, the processing device is to:
identify an entry of an overlay data structure corresponding to the first overlay section, wherein the entry of the overlay data structure comprises a memory address for a current memory location of the first overlay section; and
determine whether the first overlay section is present on the first volatile memory device based on the memory address for the current memory location of the first overlay section included in the identified entry of the overlay data structure.

12. The memory sub-system of claim 8, wherein the processing device is further to:
determine that a second overlay section is present in the first memory buffer and the first memory buffer is not available for copying of the first overlay section; and
remove the second overlay section from the first memory buffer,
wherein the first overlay section is copied from the second memory buffer to the first memory buffer responsive to removing the second overlay section from the first memory buffer.

13. The memory sub-system of claim 8, wherein the host interface comprises a peripheral component interconnect express electrical interface.

14. A non-transitory computer-readable storage medium comprising instructions that, when executed by a processing device, cause the processing device to:
copy a plurality of overlay sections from a non-volatile memory device of a memory sub-system to a first memory buffer residing on a first volatile memory device of a host system in communication with the memory sub-system, wherein each overlay section of the plurality of overlay sections comprises a respective set of executable instructions;
copy a first overlay section of the plurality of overlay sections from the first memory buffer to a second memory buffer residing on a second volatile memory device of the memory sub-system;
execute a first set of executable instructions included in the first overlay section residing in the second memory buffer;
copy a second overlay section of the plurality of overlay sections from the first memory buffer to the second memory buffer; and
execute a second set of executable instructions of the second overlay section residing in the second memory buffer.

15. The non-transitory computer-readable storage medium of claim. 14, wherein the processing device is further to:
assign one or more sets of executable instructions stored at the non-volatile memory device to a respective overlay section of the plurality of overlay sections.

16. The non-transitory computer-readable storage medium of claim 15, wherein the processing device is further to:
identify the first set of executable instructions and the second set of executable instructions stored at the non-volatile memory device, wherein the first set of executable instructions is associated with a first execution frequency and the second set of executable instructions is associated with a second execution frequency,
wherein the first set of executable instructions is assigned to the first overlay section and the second set of executable instructions is assigned to the second overlay section responsive to determining the first execution frequency is lower than the second execution frequency.

17. The non-transitory computer-readable storage medium of claim 15, Wherein the processing device is further to:
determine whether an instruction of the first set of executable instructions includes a reference to an additional instruction of a third set of executable instructions,
wherein the first set of executable instructions and the third set of executable instructions are assigned to the first overlay section responsive to determining the instruction of the first set of executable instructions includes a reference to the additional instruction of the third set of executable instructions.

18. The non-transitory computer-readable storage medium of claim 14, wherein the processing device is further to:
determine whether space is available on the second memory buffer for copying the second overlay section from the first memory buffer to the second memory buffer:
responsive to determining that space is not available on the second memory buffer, remove the first overlay section from the second memory buffer,
wherein the processing device is to copy second overlay section from the first memory buffer to the second memory buffer responsive to removing the first overlay section from the second memory buffer.

19. The non-transitory computer-readable storage medium of claim 14, wherein the processing device is further to:
allocate one or more portions of the first memory buffer for copying of the plurality of overlay sections, wherein the processing device is to copy the first overlay section and the second overlay section to the one or more allocated portions of the first memory buffer.

20. The non-transitory computer-readable storage medium of claim 19, wherein the processing device is further to:
determine, based on at least one of a size or a number of the one or more allocated portions of the first memory buffer, a number of the plurality of overlay sections to be copied to the one or more allocated portions of the first memory buffer.
